(19) United States
(12) Patent Application Publication
(10) Pub. No.: US 2024/0287733 A1
(43) Pub. Date: Aug. 29, 2024

(54) COMPOSITION, PRETREATMENT AGENT SET, PRETREATMENT METHOD, AND IMAGE FORMING METHOD

(71) Applicant: BROTHER KOGYO KABUSHIKI KAISHA, Nagoya (JP)

(72) Inventors: Atsushi NARUSE, Ichinomiya (JP); Haruki YANAGITA, Okazaki (JP); Goro OKADA, Nagoya (JP)

(21) Appl. No.: 18/418,958

(22) Filed: Jan. 22, 2024

(30) Foreign Application Priority Data
Feb. 28, 2023 (JP) 2023-030559

(51) Int. Cl. D06M 13/342; C09D 11/322; C09D 11/54

(52) U.S. Cl. CPC D06M 13/342; C09D 11/54; C09D 11/322

(57) ABSTRACT

The composition of the present disclosure is a composition included in a pretreatment agent set to be applied to a fabric prior to ejection of a pigment ink by an ink-jet printer, wherein the composition contains at least one of an amino acid or a cross-linking agent, and the cross-linking agent contains an oxazoline group-containing compound.

### REFERENCE TO RELATED APPLICATIONS

This application claims priority from Japanese Patent Application No. 2023-030559 filed on Feb. 28, 2023. The entire content of the priority application is incorporated herein by reference.

### BACKGROUND ART

When images are formed by ejecting ink to fabrics such as clothing and the like by an ink-jet method, for example, in order to improve color development and the like of the ink, a known method is to apply a pretreatment agent in advance to an area to be formed with an image.

### SUMMARY

The pretreatment agent may include various function-adding components for adding particular functions such as improving washing fastness, and the like. On the other hand, inclusion of the various function-adding components in the case where the user does not desire to add a function is problematic in terms of convenience of the user.

With the foregoing in mind, it is an object of the present disclosure to provide a composition, a pretreatment agent set, a pretreatment method, and an image forming method, improving the convenience of the user by providing an option as to whether or not to use the function-adding component in accordance with the purpose of use or the like in a scene of using the pretreatment agent.

According to the present disclosure, in a scene of using the pretreatment agent, since a pretreatment component and a function-adding component are mixed at the time of pretreatment to use, an option is provided as to whether or not to use the function-adding component in accordance with the purpose of use or the like, so that the convenience of the user is improved.

### BRIEF DESCRIPTION OF DRAWINGS

FIG. 1 is a flowchart showing an example of a pretreatment method according to the present disclosure.

FIG. 2 is a flowchart showing an example of an image forming method of the present disclosure.

FIG. 3A is a view showing an example of application of a pretreatment agent in the image forming method of the present disclosure.

FIG. 3B is a view showing another example of application of a pretreatment agent in the image forming method of the present disclosure.

FIG. 4 is a schematic diagram showing an example of a configuration of an ink-jet recording apparatus.

FIG. 5 is a front view showing an example of a configuration of an ink-jet printer of the ink-jet recording apparatus shown in FIG. 4.

FIG. 6A is a plan view of a fabric in a state of being placed on a platen of the ink-jet recording apparatus shown in FIG. 4.

FIG. 6B is a cross-sectional view taken along the line A-A of FIG. 6A.

FIG. 7 is a diagram showing a configuration of a recording control apparatus of the ink-jet recording apparatus shown in FIG. 4.

### DESCRIPTION

Compositions of the present disclosure are described below.

As described above, the composition of the present disclosure is a second composition to be applied to a fabric prior to ejection of a pigment ink by an ink-jet printer and mixed at a time of pretreatment with a first composition containing water and at least one of a polyvalent metal salt, a polymer, or a surfactant, wherein the second composition contains at least one of an amino acid or a cross-linking agent, and the cross-linking agent contains an oxazoline group-containing compound.

The amino acid may be, for example, betaine. Examples of the betaine include trimethylglycine, carnitine, γ-butyrobetaine, taurobetaine, lysine betaine, and alanine betaine. Examples of the amino acid other than the betaine include glycine, alanine, aspartic acid, glutamic acid, lysine, arginine, and histidine. By using an amino acid as the second composition, a trace of application after the pretreatment is less noticeable as compared to the case of not using the amino acid. In addition, when the amino acid is betaine, the storage stability after mixing the first composition and the second composition is improved. Furthermore, when the betaine is trimethylglycine, the trace of application is less noticeable. One kind of the amino acid may be used alone, or two or more kinds of the amino acids may be used in combination.

The cross-linking agent may contain, in addition to the oxazoline group-containing compound, other cross-linking agents such as a carbodiimide group-containing compound, an isocyanate group-containing compound, an aziridine group-containing compound, an epoxy group-containing compound, and an aqueous cross-linking agent obtained by adding a hydrophilic segment to a polycarbodiimide resin, for example. One kind of the other cross-linking agent may be used alone, or two or more kinds of the other cross-linking agents may be used in combination. The cross-linking agent may be, for example, an oxazoline group-containing compound. The crosslinking agent may consist, for example, essentially of an oxazoline group-containing compound. By using a cross-linking agent containing an oxazoline group-containing compound as the second composition, washing fastness is improved.

The composition of the present disclosure is a composition to be applied to a fabric prior to ejection of a pigment ink by an ink-jet printer, wherein the composition is a second composition containing at least one of an amino acid or a crosslinking agent, the cross-linking agent contains an oxazoline group-containing compound, and the composition is mixed at a time of pretreatment with a first composition containing water and at least one of a polyvalent metal salt, a polymer, or a surfactant.

Examples of the water include ion-exchanged water and pure water.

Examples of the polyvalent metal salt include water-soluble salts of at least one of magnesium, calcium, strontium, barium, aluminum, copper, iron, nickel, and zinc. Specific examples of the water-soluble salt include calcium chloride, calcium bromide, calcium iodide, calcium nitrite, calcium nitrate, calcium dihydrogen phosphate, calcium thiocyanate, calcium lactate, calcium fumarate, calcium citrate, magnesium chloride, magnesium bromide, magnesium iodide, magnesium sulfate, aluminum chloride, aluminum bromide, aluminum sulfate, aluminum nitrate, aluminum acetate, barium chloride, barium bromide, barium iodide, barium nitrate, barium thiocyanate, copper chloride, copper bromide, copper sulfate, copper nitrate, copper acetate, iron chloride, iron bromide, iron iodide, iron sulfate, iron nitrate, iron oxalate, iron lactate, iron fumarate, iron citrate, manganese sulfate, manganese nitrate, manganese dihydrogen phosphate, manganese acetate, manganese salicylate, manganese benzoate, manganese lactate, nickel chloride, nickel bromide, nickel sulfate, nickel nitrate, nickel acetate, tin sulfate, titanium chloride, zinc chloride, zinc bromide, zinc sulfate, zinc thiocyanate, and zinc acetate calcium chloride. The water-soluble salt may be a hydrate. One kind of the polyvalent metal salt may be used alone, or two or more kinds of the polyvalent metal salts may be used in combination.

The polymer may not be in a state of being dissolved in a dispersion medium (for example, water, or the like) but be in a state of being dispersed with a specific particle size (resin emulsion), for example. Examples of the polymer include acrylic acid resins, maleic acid ester resins, vinyl acetate resins, carbonate resins, polycarbonate resins, styrene resins, ethylene resins, polyethylene resins, propylene resins, polypropylene resins, urethane resins, polyurethane resins, and copolymer resins of the aforementioned resins. Examples of the copolymer resin include an acrylic-styrene copolymer resin and an acrylic-urethane copolymer resin. The acrylic acid resins are, for example, resin particles with polyacrylic acid or polyacrylic acid ester as the main component. Examples of the monomer constituting the acrylic acid resin include (meth)acrylic acid and acrylic acid esters such as methyl (meth)acrylate, ethyl (meth)acrylate, propyl (meth)acrylate, isopropyl (meth)acrylate, butyl (meth)acrylate, isobutyl (meth)acrylate, t-butyl (meth)acrylate, pentyl (meth)acrylate, 2-ethylhexyl (meth)acrylate, octyl (meth)acrylate, cyclopropyl (meth)acrylate, cyclopentyl (meth)acrylate, cyclohexyl (meth)acrylate, cycloheptyl (meth)acrylate, cyclooctyl (meth)acrylate, phenyl (meth)acrylate, benzyl (meth)acrylate, tolyl (meth)acrylate, tisilyl (meth)acrylate, and phenethyl (meth)acrylate. One kind of the polymer may be used alone, or two or more kinds of the polymers may be used in combination.

Examples of the surfactant include nonionic surfactants, anionic surfactants, cationic surfactants, and amphoteric surfactants. Examples of the nonionic surfactant include an acetylene glycol type surfactant, a Pluronic® (“Pluronic” is a registered trademark of BASF SE) type surfactant, an alkyl ether type surfactant, a silicone type surfactant, and a fluorine type surfactant. Examples of the anionic surfactant include a sulfate ester type surfactant, a sulfonate type surfactant, a carboxylate type surfactant, and a phosphate ester type surfactant. Examples of the cationic surfactant include an amine salt type surfactant, a quaternary ammonium salt type surfactant, and a pyridinium salt type surfactant. Examples of the amphoteric surfactant include an amino acid type surfactant, a betaine type surfactant, and an amine oxide type surfactant.

The first composition may contain, for example, other components as needed. Examples of the other component include a water-soluble organic solvent, a pH adjuster, a viscosity modifier, a surface tension modifier, and a mildewproofing agent.

Examples of the water-soluble organic solvent include polyhydric alcohols, polyhydric alcohol derivatives, alcohols, amides, ketones, keto alcohols, ethers, nitrogen-containing solvents, sulfur-containing solvents, propylene carbonates, ethylene carbonates, and 1,3-dimethyl-2-imidazolidinone. Examples of the polyhydric alcohol include glycerin, ethylene glycol, diethylene glycol, propylene glycol, butylene glycol, hexylene glycol, triethylene glycol, polyethylene glycol, dipropylene glycol, tripropylene glycol, polypropylene glycol, trimethylolpropane, 1,5-pentanediol, and 1,2,6-hexanetriol. Examples of the polyhydric alcohol derivative include ethylene glycol methyl ether, ethylene glycol ethyl ether, ethylene glycol-n-propyl ether, ethylene glycol-n-butyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, triethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, and tripropylene glycol-n-butyl ether. Examples of the alcohol include methyl alcohol, ethyl alcohol, n-propyl alcohol, isopropyl alcohol, n-butyl alcohol, sec-butyl alcohol, isobutyl alcohol, tert-butyl alcohol, and benzyl alcohol. Examples of the amide include dimethylformamide and dimethylacetamide. The ketone may be, for example, acetone. The ketoalcohol may be, for example, diacetone alcohol. Examples of the ether include tetrahydrofuran and dioxane. Examples of the nitrogen-containing solvent include pyrrolidone, 2-pyrrolidone, N-methyl-2-pyrrolidone, cyclohexylpyrrolidone, and triethanolamine. Examples of the sulfur-containing solvent include thiodiethanol, thiodiglycol, thiodiglycerol, sulfolane, and dimethylsulfoxide. One kind of the water-soluble organic solvent may be used alone, or two or more kinds of the water-soluble organic solvents may be used in combination.

The composition of the present disclosure is applied to a fabric prior to ejection of a pigment ink by an ink-jet printer and mixed at the time of pretreatment with a first composition containing water and at least one of a polyvalent metal salt, a polymer, or a surfactant. Therefore, the composition of the present disclosure (the second composition) is not mixed with the first composition at the time of manufacture, for example. In addition, the time of pretreatment may be, for example, any time after the composition of the present disclosure and the first composition are obtained by the user. For example, the time of pretreatment may be the time of preparation for the application or immediately before the application.

The first composition may contain, for example, the polyvalent metal salt, and the lower limit of the content ratio of the amino acid contained in the second composition relative to 100 parts by weight of the polyvalent metal salt may be greater than 0 parts by weight, greater than or equal to 5 parts by weight, greater than or equal to 10 parts by weight, greater than or equal to 13 parts by weight, greater than or equal to 15 parts by weight, greater than or equal to 20 parts by weight, greater than or equal to 25 parts by weight, greater than or equal to 30 parts by weight, greater than or equal to 40 parts by weight, greater than or equal to 50 parts by weight, or greater than or equal to 55 parts by weight, and the upper limit of the content ratio of the amino acid contained in the second composition relative to 100 parts by weight of the polyvalent metal salt may be less than or equal to 200 parts by weight, less than or equal to 190 parts by weight, less than or equal to 185 parts by weight, less than or equal to 180 parts by weight, less than or equal to 150 parts by weight, less than or equal to 130 parts by weight, less than or equal to 100 parts by weight, less than or equal to 90 parts by weight, less than or equal to 85 parts by weight, less than or equal to 70 parts by weight, or less than or equal to 60 parts by weight.

The first composition may contain, for example, the polymer, and the lower limit of the content ratio of the cross-linking agent contained in the second composition relative to the 100 parts by weight of the polymer may be greater than 0 parts by weight, greater than or equal to 5 parts by weight, greater than or equal to 10 parts by weight, greater than or equal to 13 parts by weight, greater than or equal to 15 parts by weight, greater than or equal to 20 parts by weight, and the upper limit of the content ratio of the cross-linking agent contained in the second composition relative to the 100 parts by weight of the polymer may be less than or equal to 120 parts by weight, less than or equal to 115 parts by weight, less than or equal to 112 parts by weight, less than or equal to 100 parts by weight, less than or equal to 90 parts by weight, less than or equal to 70 parts by weight, less than or equal to 50 parts by weight, less than or equal to 40 parts by weight, less than or equal to 35 parts by weight, or less than or equal to 30 parts by weight.

The second composition is diluted with water at the time of pretreatment, for example. Examples of the water include ion-exchanged water and pure water. The dilution is not particularly limited, and for example, the second composition may be diluted at an appropriate ratio depending on the purpose of use of the user. By setting the concentration of the second composition based on the premise that the second composition is diluted with water at the time of pretreatment to use, for example, convenience in transporting the second composition is improved. In addition, the cost in transporting is also reduced. Further, the dilution may adjust the performance as a pretreatment agent obtained by mixing the first composition and the second composition.

Next, a pretreatment agent set of the present disclosure will be described.

The pretreatment agent set is a pretreatment agent set to be applied to a fabric prior to ejection of a pigment ink by an ink-jet printer, wherein the pretreatment agent set includes a first composition and a second composition.

The first composition contains water and at least one of a polyvalent metal salt, a polymer, or a surfactant. The first composition is, for example, the same as the first composition explained in the above description as to the composition of the present disclosure.

The second composition contains at least one of an amino acid or a cross-linking agent, and the cross-linking agent contains an oxazoline group-containing compound. The second composition is, for example, the same as the second composition explained in the above description as to the composition of the present disclosure.

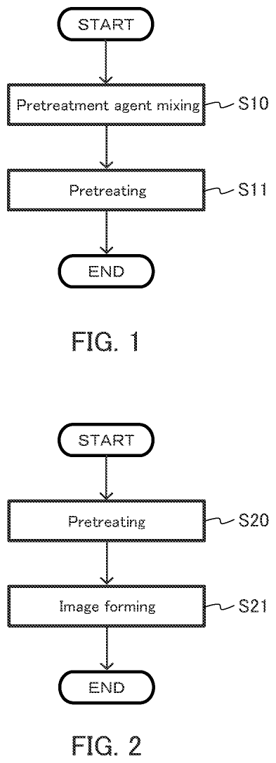

Next, a pretreatment method of the present disclosure will be described with reference to FIG. 1. FIG. 1 is a flowchart showing an example of the pretreatment method of the present disclosure.

The pretreatment method of the present disclosure is, as described above, a method for pretreating a fabric to be printed by ejecting a pigment ink by an ink-jet printer, including pretreatment agent mixing (S10) and pretreating (S11).

In the pretreatment agent mixing (S10), the first composition and the second composition are mixed. The first composition contains water and at least one of, a polyvalent metal salt, a polymer, or a surfactant. The first composition is, for example, the same as the first composition explained in the above description as to the pretreatment agent set of the present disclosure. The second composition contains at least one of an amino acid or a cross-linking agent, and the cross-linking agent contains an oxazoline group-containing compound. The second composition is, for example, the same as the second composition explained in the above description as to the pretreatment agent set of the present disclosure.

The pretreatment agent mixing (S10) may be performed by, for example, a pretreatment agent mixer configured to mix the first composition and the second composition, included in the ink-jet printer. The pretreatment agent mixing may be performed by, for example, a mixing device independent of the ink-jet printer, or may be performed manually by a user of using the first composition.

In the pretreating (S11), the fabric is pretreated with the first composition mixed with the second composition (hereinafter, also referred to as “pretreatment agent after mixing”). In the pretreating (S11), for example, the first composition mixed with the second composition may be supplied to the ink-jet printer to pretreat the fabric or a user may pretreat the fabric manually with the first composition mixed with the second composition. Examples of the manual operation by the user include operations using a spray, a stamp, a brush, a roller, and the like. The pretreating (S11) may be performed by, for example, a pretreatment unit included in the ink-jet printer or a pretreatment device independent of the ink-jet printer.

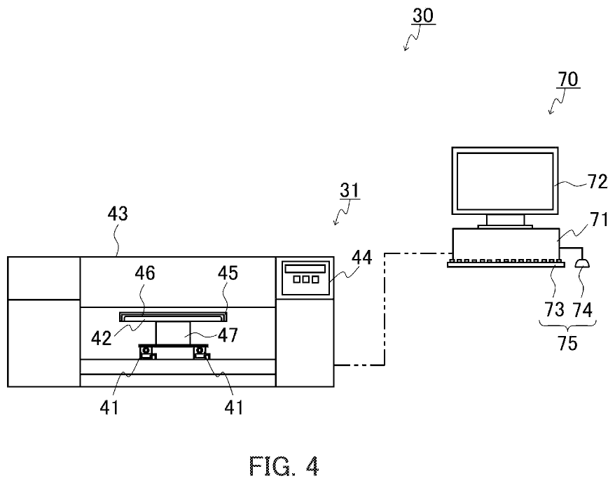

The ink-jet printer may include, for example, a platen, and the platen may have the same configuration as the platen of the ink-jet printer shown in FIG. 4 to be described below.

Next, the image forming method of the present disclosure will be described with reference to FIG. 2. FIG. 2 is a flowchart showing an example of an image forming method of the present disclosure.

The image forming method of the present disclosure is a method for forming an image on a fabric using an ink-jet printer, including pretreating (S20) and image forming (S21). In the pretreating (S20), the fabric is pretreated with a first composition mixed with a second composition. The first composition contains water and at least one of a polyvalent metal salt, a polymer, or a surfactant. The first composition is, for example, the same as the first composition explained in the above description as to the pretreatment agent set of the present disclosure. The second composition contains at least one of an amino acid or a cross-linking agent, and the cross-linking agent contains an oxazoline group-containing compound. The second composition is, for example, the same as the second composition explained in the above description as to the pretreatment agent set of the present disclosure. In the image forming (S21), an image is formed on the pretreated fabric by printing. The image forming method of the present disclosure may include, for example, heat treating, compressing, and heat-fixing to be described below. The image forming method of the present disclosure may be, for example, the image forming method described in JP 2019-183126 A.

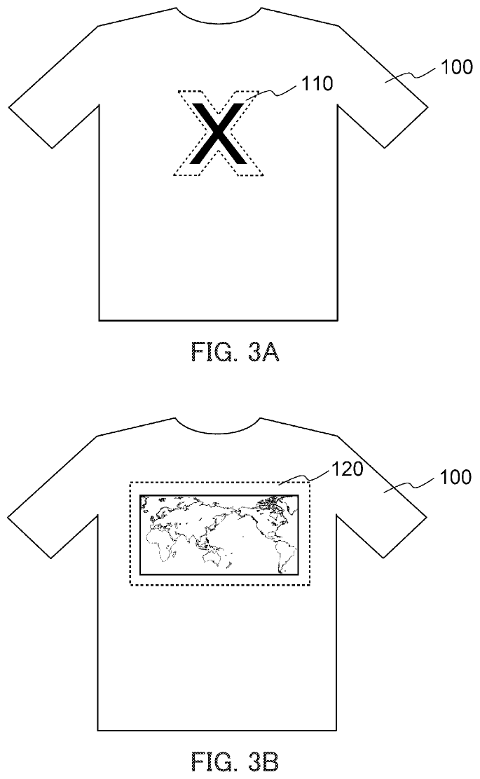

In the pretreating (S20), the mixed pretreatment agent may be applied to the entire or a part of the image forming surface of the fabric. When the mixed pretreatment agent is applied to a part of the image forming surface of the fabric, a pretreatment agent applying area (an area pretreated with the pretreatment agent) may be the same area as at least a printing area (an area of the imaging surface of the fabric printed with the ink). When the mixed pretreatment agent is applied to a part of the image forming surface of the fabric, the size of the pretreatment agent applying area may be larger than the printing area. For example, as shown in FIG. 3A, in the case of printing the character (X) on the fabric (T-shirt in the present example) 100, the mixed pretreatment agent may be applied so as to form a pretreatment agent applying area 110 wider than the line width of the character. Further, as shown in FIG. 3B, in the case of printing a design on the fabric (T-shirt) 100, the pretreatment agent may be applied so as to form a pretreatment agent applying area 120 larger than the design.

The image forming method of the present disclosure may include, after the pretreating (S20), at least one of heat treating by applying heat treatment to the pretreatment agent applying area and compressing the pretreatment agent applying area. The heat treatment may be applied by using a commercially available hot pressing machine, oven, belt conveyor oven, or the like, for example. In the case of using the hot press machine, when the heat treatment is performed with a smooth-surface Teflon® (“Teflon” is a registered trademark of DuPont de Nemours, Inc.) sheet being placed on the pretreatment agent applying area, the fuzz of the fabric is reduced, and the image forming (S21) after the heat treating is allowed to be performed smoothly. The temperature of the heat treatment is not limited to a particular temperature, and is, for example, from 160° C. to 185° C. The compression may be performed under the same conditions as the heat treatment using, for example, a commercially available hot press machine.

The image forming (S21) may include forming a base area in the pretreatment agent applying area using a first ink, and forming an image on the base area using a second ink. For example, a white ink may be used as the first ink, and a color ink may be used as the second ink. According to an aspect of using a white ink as the first ink and a color ink as the second ink, a color image with good color development may be formed even on a dark-colored fabric.

The image forming (S21) may be performed using, for example, the ink-jet recording apparatus shown in FIG. 4. As shown in FIG. 4, an ink-jet recording apparatus 30 includes an ink-jet printer 31 configured to record a desired image by ejecting an ink to the fabric and a recording control apparatus 70 configured to acquire image data of the desired image and control the ink-jet printer 31, wherein the ink-jet printer 31 and the recording control apparatus 70 are connected via an interface.

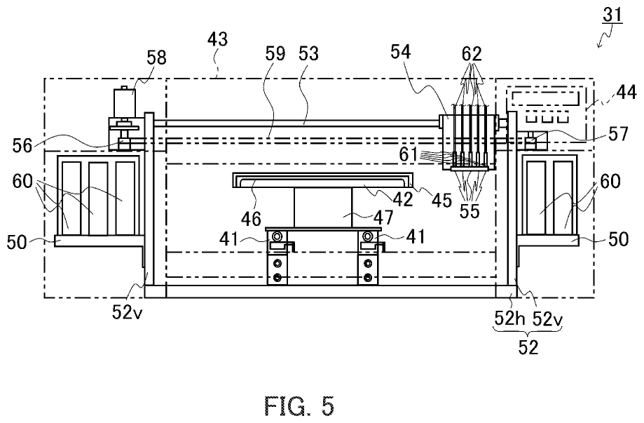

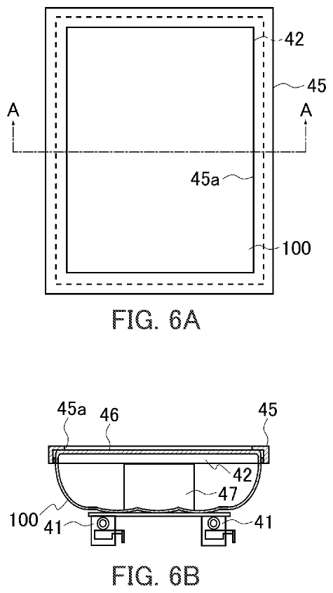

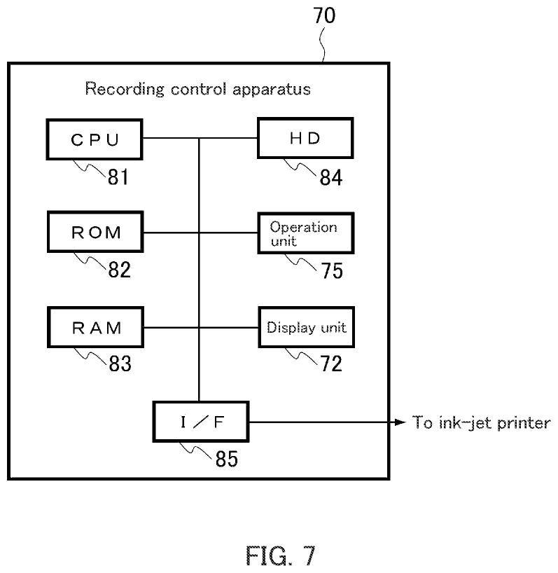

The ink-jet printer 31 is provided with a frame 52 as shown in FIG. 5. The frame 52 has a horizontal portion 52h located at the bottom of the printers 31 and two vertical portions 52v vertically rising from both ends of the horizontal portion 52h. In FIG. 5, the identical parts to the parts shown in FIG. 4 are indicated with identical reference signs. The same applies to FIGS. 6A, 6B, and 7.

A slide rail 53 is horizontally extended so as to link the upper parts of the two vertical portions 52v. The slide rail 53 is provided with a carriage 54 configured to slide along the longitudinal direction (main scanning direction) of the slide rail 53. On the lower surface of the carriage 54, five piezoelectric ink-jet heads (ink ejectors) 55 configured to eject five colors of inks are provided.

Pulleys 56 and 57 are supported by the upper parts of the two vertical portions 52v, respectively. The motor shaft of a motor 58, supported by the vertical portion 52v, is linked to one of the pulleys (pully 56). An endless belt 59 is extended between the pulleys 56 and 57, and the carriage 54 is fixed on an appropriate part of the endless belt 59. In response to the forward and reverse rotations of one of the pulleys (pulley 56) driven by the motor 58, the carriage 54 is linearly reciprocated along the longitudinal direction (main scanning direction) of the slide rail 53. As a result, the ink-jet head 55 is reciprocated.

Mounting units 50 are formed on the two vertical portions 52v, respectively, and ink cartridges 60 are detachably mounted on the mounting units 50, respectively. The ink cartridges 60 of two colors are mounted on one of the two mounting units 50 and the ink cartridges 60 of three colors are mounted on the other of the two mounting units 50. Ink bags (not shown) provided in the ink cartridges 60 are connected to five ink tanks 61 located above the ink-jet heads 55 through flexible tubes 62. Since the five ink tanks 61 are in communication with the ink-jet heads 55 as described below, inks are supplied from the ink cartridges 60 to the ink-jet heads 55.

On the horizontal portion 52h of the frame 52, a slide mechanism 41 is provided as a carrying unit, and a platen (support) 42 is supported by the slide mechanism 41 from below. The platen 42 is provided with a fixing frame (fixing unit) 45 configured to position the fabric such as a T-shirt with the surface including an area to be recorded up and set the T-shirt in the state of being tautly stretched and having no wrinkles or unevenness. The ink-jet printer 31 of the present example includes one platen 42. The number of the platens however is not limited to one in the present disclosure and two or more platens may be provided as needed.

In order to reciprocate the platen 42 in the direction perpendicular to the paper surface in FIG. 3 (the sliding direction of the slide mechanism 41, the subscanning direction of the ink-jet printer 31), a platen carrying mechanism (not shown) is provided. As the platen carrying mechanism, for example, a rack-and-pinion mechanism, a mechanism using an endless belt, and the like may be applied.

FIGS. 6A and 6B show a fabric in a state of being placed on the platen. FIG. 6A is a plan view and FIG. 6B is a cross-sectional view taken along the line A-A of FIG. 6A. As shown in FIGS. 6A and 6B, the platen 42 has a rectangular shape having the longitudinal direction in the subscanning direction in a planer view and has a support surface 46 for supporting a T-shirt 100. The lower surface of the platen 42 at the farthest side in the direction perpendicular to the paper surface in FIG. 6B is linked to the slide mechanism 41 facing the platen 42 through a support member 47.

The fixing frame 45 having an L-shaped cross section is configured to cover the four sides of the support surface 46 of the platen 42. An opening 45a having an opening area slightly smaller than the area of the support surface 46 of the platen 42 is formed on the surface of the fixing frame 45 facing the support surface 46 of the platen 42. In setting of the T-shirt 100 on the platen 42, the T-shirt 100 is placed on the platen 42 from the hem side in such a manner that the support surface 46 of the platen 42 is covered with the T-shirt 100 and the T-shirt 100 is fixed with the fixing frame 45. The fixing frame 45 is provided rotatably by a rotation unit (not shown) provided at the end of the platen 42, positioned at the farthest side in the direction perpendicular to the paper surface in FIG. 6B. After the platen 42 is covered with the T-shirt 100, the fixing frame 45 is rotated so as to fit to the platen 42, thereby fixing the T-shirt 100 between the platen 42 and the fixing frame 45.

The ink-jet printer 31 includes a cover 43. The ink-jet heads 55, the slide mechanism 41, and the like are covered with the cover 43. FIG. 5 shows the cover 43 in perspective view illustrated by chain double-dashed lines. An operation panel 44 provided with a liquid crystal panel and operation buttons is provided at the upper right part of the front surface of the cover 43.

The five ink-jet heads 55 shown in FIG. 5 corresponding to the inks of five colors (white, yellow, magenta, cyan, and black) are arranged in parallel along the reciprocating direction of the carriage 54, and are in communication with the corresponding ink cartridges 60 through the flexible tubes 62 and the ink tanks 61. As the configuration for supplying inks to the ink-jet heads, for example, a conventionally known configuration may be employed (for example, see JP 2004-291461 A). As to the five ink-jet heads 55, a head unit including ejectors configured to eject the inks of four colors (yellow, magenta, cyan, and black) and a head unit including an ejector configured to eject a white ink may be aligned in the subscanning direction. Besides the five ink-jet heads 55, the ink-jet printer 31 may further include a liquid ejector as a unit configured to apply the pretreatment agent to the fabric in advance. Further, the ink-jet printer 31 may include, for example, a unit configured to apply the mixed pretreatment agent to the fabric in advance by spraying or the like.

The ink-jet heads 55 are disposed in such a manner that a small gap is formed between the lower surfaces of the ink-jet heads 55 and the support surface 46 of the platen 42, and an area to be recorded of the T-shirt 100 set on the platen 42 is fed to the gap when an image is recorded on the T-shirt 100. With the above mentioned configuration, while reciprocating the ink-jet heads 55 by the carriage 54, by ejecting the color inks from plural ejection nozzles with micro-diameters formed on the bottom surfaces of the ink-jet heads 55 to the T-shirt 100, the color inks are held on the surface of the fabric. As a result, a desired color image is recorded on the T-shirt 100.

The recording control apparatus 70 shown in FIG. 4 is, for example, configured using a general-purpose personal computer (PC) and includes a main body 71, a display as a display unit 72, and a keyboard 73 and a mouse (pointing device) 74 as an operation unit 75.

FIG. 7 is a diagram showing a configuration of a recording control apparatus 70 of the ink-jet recording apparatus shown in FIG. 4. The recording control apparatus 70 includes a central processing unit (CPU) 81, a read only memory (ROM) 82, a random access memory (RAM) 83, a hard disk (HD) 84, an operation unit 75, a display unit 72, and an interface (I/F) 85. The central processing unit (CPU) 81, the read only memory (ROM) 82, the random access memory (RAM) 83, the hard disk (HD) 84, the operation unit 75, the display unit 72, and the interface (I/F) 85 are connected via a bus.

The HD 84 stores various programs for use in control of the operation of the recording control apparatus 70. The HD 84 further stores various image data downloaded via the internet or the like or created by software and various data for each kind of fabric (for example, T-shirt). The CPU 81 performs various operations and processes based on signals input using the operation unit 75 and various programs and data stored in the ROM 82, the RAM 83, and the HD 84. Then, data and the like are sent to the ink-jet printer 31 via the interface 85. The RAM 83 is a volatile storage device configured to read and write and stores results of the operations and the like obtained in the CPU 81. The interface 85 is connected to the interface of the ink-jet printer 31 and allows the recording control apparatus 70 and the ink-jet printer 31 to communicate with each other.

The recording of a desired image on the T-shirt 100 using the ink-jet recording apparatus 30 of the present example may be performed as follows, for example. First, the data of a desired image to be recorded on the T-shirt 100 is acquired via the keyboard 73 and the mouse 74 of the recording control apparatus 70. As to the acquisition of the image data, the image data is created using software installed in the recording control apparatus 70 or the image data preliminarily stored in the HD 84 is selected.

Next, the T-shirt 100 is fixed to the platen 42. That is, the T-shirt 100 is placed on the platen 42 from the hem side, stretched along the support surface 46 of the platen 42, and fixed with the fixing frame 45 in the state of having no wrinkles.

Subsequently, in response to the instruction of recording by a user, the image data is sent to the ink-jet printer 31 via the interface 85, inks are ejected from the ink-jet heads 55 based on the image data, and an image is recorded on the T-shirt 100 fixed on the platen 42.

The method for forming an image of the present disclosure may include, after the image forming (S21), heat-fixing the ink on the fabric by applying heat treatment to a printing area of the fabric. The heat-fixing may be performed, for example, using the same apparatus and under the same condition as the heat treating. The heat-fixing may be performed using the apparatus described in JP 2009-209493 A, for example. The apparatus described in JP 2009-209493 A applies 180° C. heat and pressure to the fabric.

### EXAMPLES

Next, examples of the present disclosure are described together with comparative examples. The present disclosure is not limited to the following examples and comparative examples.

### Examples 1 to 14 and Comparative Examples 1 to 12

The second compositions summarized in Tables 1 to 4 were added to the first compositions summarized in Tables 1 to 4, and stirred and mixed to obtain pretreatment agent sets (the first compositions and the second compositions) of Examples 1 to 14 and Comparative Examples 1 to 12 summarized in Tables 1 to 4. In Comparative Examples 7 to 12 of Table 4, the closed circle (●) indicates the case of including each of the components summarized Table 4, and the blank indicates the case of not including each of the components summarized Table 4.

The pretreatment agent sets of Examples 1 to 14 and Comparative Examples 1 to 6 were subjected to (a) convenience evaluation, (b) propriety evaluation of pretreatment with first composition alone, (c) storage stability evaluation, (d) pretreatment agent application trace evaluation, (e) washing fastness evaluation, and (f) color development evaluation by the following methods. The pretreatment agent sets of Comparative Examples 7 to 12 were subjected to (a) convenience evaluation and (b) propriety evaluation of pretreatment with first composition.

### (a) Convenience Evaluation

The convenience evaluation was made according to the following evaluation criteria.

### Criteria for Convenience Evaluation

∘: the first composition and the second composition are not in the mixed form at the time of purchase (at the time of acquisition) by the user. x: the first composition and the second composition are in the mixed form at the time of purchase (at the time of acquisition) by the user.
   (b) Propriety Evaluation of Pretreatment with First Composition Alone

Using each of the first compositions of Examples 1 to 14 and Comparative Examples 1 to 12 summarized in Tables 1 to 4 alone, an image was formed on a black T-shirt (trade name: Ultra Cotton, material: 100% cotton, manufactured by GILDAN) by the following steps to obtain a sample for evaluation. L* of the area applied with the first composition of the sample for evaluation and L* of the area not applied with the first composition of the sample for evaluation were measured using a CIE1976L*a*b* color space scale colorimeter exact manufactured by X-Rite.

### Pretreating

Each of the first compositions summarized in Tables 1 to 4 was applied to the image forming surface of the T-shirt by spraying. The amount of the first composition applied was 0.03 g/cm².

### Heat Treating

The area applied with the first composition of the T-shirt after the pretreating was subjected to heat treatment for 35 seconds using a heat press machine set at 180° C.

### Image Forming

An ink-jet printer (trade name: GTXPro, manufactured by Brother Industries, Ltd.) was used to print by ejecting inks to a T-shirt applied with the first composition. Inks of white (trade name: GCX-4W, manufactured by Brother Industries, Ltd.), black (trade name: GCX-4K, manufactured by Brother Industries, Ltd.), magenta (trade name:GCX-4M, manufactured by Brother Industries, Ltd.), cyan (trade name: GCX-4C, manufactured by Brother Industries, Ltd.), and yellow (trade name: GCX-4Y, manufactured by Brother Industries, Ltd.) were used.

### Heat-Fixing

After the image forming, the white ink was thermally fixed to the printed area of the T-shirt using an oven set at 160° C. The heating time in the heat-fixing was 3.5 minutes.

Criteria for Propriety Evaluation of Pretreatment with First Composition Alone
∘: ΔL* was greater than or equal to 80. x: ΔL* was less than 80.

### (c) Storage Stability Evaluation

(i) The first compositions of Examples 1 to 14 and Comparative Examples 1 to 6 summarized in Tables 1 to 3 alone or (ii) the first compositions and the second compositions of Examples 1 to 14 and Comparative Examples 1 to 6 summarized in Tables 1 to 3 were placed in glass containers, and the glass containers were stored at 72° C. for 72 hours, and appearance changes before and after storage were visually evaluated according to the following evaluation criteria.

### Criteria for Storage Stability Evaluation

∘: the solid component did not precipitate on the inner wall of the glass container, and the phase separation of the composition did not occur. x: the solid component precipitated on the inner wall of the glass container, or the phase separation of the composition occurred.

### (d) Pretreatment Agent Application Trace Evaluation

Using each of the pretreatment agent sets of Examples 1 to 14 and Comparative Examples 1 to 6 summarized in Tables 1 to 3, a red T-shirt (part number: 00085-CVT, material: 100% cotton, manufactured by TOMS CO., LTD.) was pretreated by the following steps to obtain a sample for evaluation. L*a*b* of the area applied with the pretreatment agent of the sample for evaluation and L*a*b* of the area not applied with the pretreatment agent of the sample for evaluation were measured using a CIE1976L*a*b* color space scale colorimeter exact manufactured by X-Rite. AE*ab was calculated as the color difference between the area applied with the pretreatment agent of the sample and the area not applied with the pretreatment agent of the sample according to the following equation. The smaller ΔE*ab is, the less noticeable the pretreatment agent application trace is.

$$Δ {E}^{*} ab = {\{ {( {L}_{1}^{*} - {L}_{2}^{*} )}^{2} + {( {a}_{1}^{*} - {a}_{2}^{*} )}^{2} + {( {b}_{1}^{*} - {b}_{2}^{*} )}^{2} \}}^{1 / 2}$$

L₁*: L* of the area applied with the pretreatment agent, L₂*: L* of the area not applied with the pretreatment agent, a₁*: a* of the area applied with the pretreatment agent, a₂*: a* of the area not applied with the pretreatment agent, b₁*: b* of the area applied with the pretreatment agent, b₂*: b* of the area not applied with the pretreatment agent.

### Pretreating

Each of the pretreatment agent sets summarized in Tables 1 to 3 was applied to the T-shirt by spraying. The amount of the pretreatment agent applied was 0.03 g/cm².

### Heat Treating

The area applied with the pretreatment agent of the T-shirt after the pretreating was subjected to heat treatment for 35 seconds using a heat press machine set at 180° C.

### Heat-Fixing

After the image forming, the white ink was thermally fixed to the printed area of the T-shirt using an oven set at 160° C. The heating time in the heat-fixing was 3.5 minutes.

### Criteria for Pretreatment Agent Application Trace Evaluation

A: ΔE* ab≤2, B: 2<ΔE*ab≤3, C: 3<ΔE*ab≤5, D: 5<ΔE*ab≤6, E: 6<ΔE*ab

### (e) Washing Fastness Evaluation

The pretreating was performed in the same manner as in the above-described “propriety evaluation of pretreatment with first composition alone” except that the pretreating was performed using, in place of the first composition, each of the pretreatment agent sets of Examples 1 to 14 and Comparative Examples 1 to 6 summarized in Tables 1 to 3. After the pretreating, the heat treating was performed in the same manner as in the above-described “propriety evaluation of pretreatment with first composition alone”. Next, the image forming was performed in the same manner as in the above-described “propriety evaluation of pretreatment with first composition alone”. After the image forming, the heat-fixing was performed in the same manner as in the above-described “propriety evaluation of pretreatment with first composition alone” to obtain a sample for washing fastness evaluation. The samples for evaluation were subjected to the test according to JIS L1930 C4M method and the washing fastness was evaluated by washing grade. As for the washing grade, “1” is the worst and “5” is the best, as described in the evaluation criteria below.

### Criteria for Washing Fastness Evaluation

As for the criteria for the washing fastness evaluation, the washing fastness was evaluated in nine levels: “5”, “4-5”, “4”, “3-4”, “3”, “2-3”, “2”, “1-2”, and “1”.

### (f) Color Development Evaluation

Samples for color development evaluation were obtained in the same manner as in the above-described “washing fastness evaluation” using the pretreatment agent sets of Examples 1 to 14 and Comparative Examples 1 to 6 summarized in Tables 1 to 3. L* of the printed area of the sample for evaluation was measured using a CIE1976L*a*b* color space scale colorimeter exact manufactured by X-Rite.

### Criteria for Color Development Evaluation

∘: ΔL* was greater than or equal to 80. x: ΔL* was less than 80.

The compositions and the evaluation results of the pretreatment agent sets of Examples 1 to 14 and Comparative Examples 1 to 12 are summarized in Tables 1 to 4.

TABLE 1

| | | | Examples | | | | | | | |
|---|---|---|---|---|---|---|---|---|---|---|
| | | | 1 | | 2 | | 3 | | 4 | |
| First composition/second composition | | | First | Second | First | Second | First | Second | First | Second |
| Polyvalent metal salt | | Calcium nitrate tetrahydrate | 18.0 | | 18.0 | | 18.0 | | 18.0 | |
| Resin emulsion | | Acrylic emulsion | 4.5 | | 4.5 | | 4.5 | | 4.5 | |
| Amino acid | Betaine | Trimethylglycine | | 2.5 | | 5.0 | | 7.5 | | 10.0 |
| | Non-betaine | Carnitine | | | | | | | | |
| | | Glycine | | | | | | | | |

| | | | | | |
|---|---|---|---|---|---|
| Cross-linking | EPOCROS ® WS-700 (*1) | | | | |
| agent | CARBODILITE ® V-02 (*2) | | | | |
| Surfactant | OLFINE ® E1010 (*3) | 0.5 | 0.5 | 0.5 | 0.5 |
| Preservative | PROXEL ™ GXL(S)(*4) | 0.1 | 0.1 | 0.1 | 0.1 |

| | | | | |
|---|---|---|---|---|
| Water | Balance | Balance | Balance | Balance |

| Content ratio of amino acid relative to 100 parts | | 13.9 | 27.8 | 41.7 | 55.6 |
|---|---|---|---|---|---|
| by weight of polyvalent metal salt (parts by weight) | | | | | |
| Content ratio of cross-linking agent relative to 100 parts | | — | — | — | — |
| by weight of polyvalent metal salt (parts by weight) | | | | | |
| Convenience | | ∘ | ∘ | ∘ | ∘ |
| Propriety of pretreatment with first composition alone | | ∘ | ∘ | ∘ | ∘ |
| Storage stability | First composition alone | ∘ | ∘ | ∘ | ∘ |
| | First composition + | — | — | — | — |
| | second composition | | | | |

| | | | | | |
|---|---|---|---|---|---|
| Pretreatment agent | ΔE | 5.5 | 3.8 | 2.1 | 0.6 |
| application trace | Assessment | D | C | B | A |

| | | | | |
|---|---|---|---|---|
| Washing fastness (JIS L1930 C4M method, washing grade) | — | — | — | — |
| Color development | ∘ | ∘ | ∘ | ∘ |

| | | | Examples | | | | | | Comparative | |
|---|---|---|---|---|---|---|---|---|---|---|
| | | | 5 | | 6 | | 7 | | Example 1 | |
| First composition/second composition | | | First | Second | First | Second | First | Second | First | Second |
| Polyvalent metal salt | | Calcium nitrate tetrahydrate | 18.0 | | 18.0 | | 18.0 | | 18.0 | |
| Resin emulsion | | Acrylic emulsion | 4.5 | | 4.5 | | 4.5 | | 4.5 | |
| Amino acid | Betaine | Trimethylglycine | | 12.5 | | 15.0 | | 33.0 | | |
| | Non-betaine | Carnitine | | | | | | | | |
| | | Glycine | | | | | | | | |

| | | | | | |
|---|---|---|---|---|---|
| Cross-linking | EPOCROS ® WS-700 (*1) | | | | |
| agent | CARBODILITE ® V-02 (*2) | | | | |
| Surfactant | OLFINE ® E1010 (*3) | 0.5 | 0.5 | 0.5 | 0.5 |
| Preservative | PROXEL ™ GXL(S)(*4) | 0.1 | 0.1 | 0.1 | 0.1 |

| | | | | |
|---|---|---|---|---|
| Water | Balance | Balance | Balance | Balance |

| Content ratio of amino acid relative to 100 parts | | 69.4 | 83.3 | 183.3 | — |
|---|---|---|---|---|---|
| by weight of polyvalent metal salt (parts by weight) | | | | | |
| Content ratio of cross-linking agent relative to 100 parts | | — | — | — | — |
| by weight of polyvalent metal salt (parts by weight) | | | | | |
| Convenience | | ∘ | ∘ | ∘ | — |
| Propriety of pretreatment with first composition alone | | ∘ | ∘ | ∘ | ∘ |
| Storage stability | First composition alone | ∘ | ∘ | ∘ | ∘ |
| | First composition + | — | — | — | — |
| | second composition | | | | |

| | | | | | |
|---|---|---|---|---|---|
| Pretreatment agent | ΔE | 1.0 | 1.8 | 5.7 | 6.9 |
| application trace | Assessment | A | A | D | E |

| | | | | |
|---|---|---|---|---|
| Washing fastness (JIS L1930 C4M method, washing grade) | — | — | — | 2-3 |
| Color development | ∘ | ∘ | ∘ | ∘ |

Footnotes in Table 1
(*1) oxazoline group-containing compound, manufactured by Nippon Shokubai Co., Ltd., “EPOCROS” is a registered trademark of Nippon Shokubai Co., Ltd.;
(*2) carbodiimide-containing compound, manufactured by Nisshinbo Chemical Inc. “CARBODILITE” is a registered trademark of Nisshinbo Chemical Inc.;
(*3) manufactured by Nissin Chemical Industry Co., Ltd., “OLFINE” is a registered trademark of Nissin Chemical Industry Co., Ltd.;
(*4)manufactured by Lonza K.K.

TABLE 2

| | | | Examples | | | | | | Comparative | |
|---|---|---|---|---|---|---|---|---|---|---|
| | | | 8 | | 9 | | 10 | | Example 1 | |
| First composition/second composition | | | First | Second | First | Second | First | Second | First | Second |
| Polyvalent metal salt | | Calcium nitrate tetrahydrate | 18.0 | | 18.0 | | 18.0 | | 18.0 | |
| Resin emulsion | | Acrylic emulsion | 4.5 | | 4.5 | | 4.5 | | 4.5 | |
| Amino acid | Betaine | Trimethylglycine | | 10.0 | | | | | | |
| | Non-betaine | Carnitine | | | | 10.0 | | | | |
| | | Glycine | | | | | | 10.0 | | |

| | | | | | |
|---|---|---|---|---|---|
| Cross-linking | EPOCROS ® WS-700 (*1) | | | | |
| agent | CARBODILITE ® V-02 (*2) | | | | |
| Surfactant | OLFINE ® E1010 (*3) | 0.5 | 0.5 | 0.5 | 0.5 |
| Preservative | PROXEL ™ GXL(S)(*4) | 0.1 | 0.1 | 0.1 | 0.1 |

| | | | | |
|---|---|---|---|---|
| Water | Balance | Balance | Balance | Balance |

| Content ratio of amino acid relative to 100 parts | | 55.6 | 55.6 | 55.6 | — |
|---|---|---|---|---|---|
| by weight of polyvalent metal salt (parts by weight) | | | | | |
| Content ratio of cross-linking agent relative to 100 parts | | — | — | — | — |
| by weight of polyvalent metal salt (parts by weight) | | | | | |
| Convenience | | ∘ | | | — |
| Propriety of pretreatment with first composition alone | | ∘ | ∘ | ∘ | ∘ |
| Storage stability | First composition alone | ∘ | ∘ | ∘ | ∘ |
| | First composition + | ∘ | x | x | — |
| | second composition | | | | |

| | | | | | |
|---|---|---|---|---|---|
| Pretreatment agent application trace | Assessment | A | B | B | B |

| | | | | |
|---|---|---|---|---|
| Washing fastness (JIS L1930 C4M method, washing grade) | 3 | 3 | 3 | 2-3 |
| Color development | ∘ | ∘ | ∘ | ∘ |

Footnotes in Table 2
(*1) oxazoline group-containing compound, manufactured by Nippon Shokubai Co., Ltd.,;
(*2) carbodiimide-containing compound, manufactured by Nisshinbo Chemical Inc.;
(*3) manufactured by Nissin Chemical Industry Co., Ltd.;
(*4)manufactured by Lonza K.K.

TABLE 3

| | | | Examples | | | | | | | | Comparative | |
|---|---|---|---|---|---|---|---|---|---|---|---|---|
| | | | 11 | | 12 | | 13 | | 14 | | Examples 1 | |
| First composition/second composition | | | First | Second | First | Second | First | Second | First | Second | First | Second |
| Polyvalent | | Calcium nitrate | 18.0 | | 18.0 | | 18.0 | | 18.0 | | 18.0 | |
| metal salt | | tetrahydrate | | | | | | | | | | |
| Resin emulsion | | Acrylic emulsion | 4.5 | | 4.5 | | 4.5 | | 4.5 | | 4.5 | |
| Amino | Betaine | Trimethylglycine | | | | | | | | | | |
| acid | Non- | Carnitine | | | | | | | | | | |
| | betaine | Glycine | | | | | | | | | | |

| | | | | | | | | | | |
|---|---|---|---|---|---|---|---|---|---|---|
| Cross- | EPOCROS ® | | 0.5 | | 1.0 | | 1.5 | | 5.0 | |
| linking | WS-700 (*1) | | | | | | | | | |
| agent | CARBODILITE ® | | | | | | | | | |
| | V-02 (*2) | | | | | | | | | |
| Surfactant | OLFINE ® | 0.5 | | 0.5 | | 0.5 | | 0.5 | | 0.5 |
| | E1010 (*3) | | | | | | | | | |
| Preservative | PROXEL ™ | 0.1 | | 0.1 | | 0.1 | | 0.1 | | 0.1 |
| | GXL(S)(*4) | | | | | | | | | |

| | | | | | |
|---|---|---|---|---|---|
| Water | Balance | Balance | Balance | Balance | Balance |

| Content ratio of amino acid relative | | — | — | — | — | — |
|---|---|---|---|---|---|---|
| to 100 parts by weight of polyvalent | | | | | | |
| metal salt (parts by weight) | | | | | | |
| Content ratio of cross-linking agent relative | | 11.1 | 22.2 | 33.3 | 111.1 | — |
| to 100 parts by weight of polyvalent | | | | | | |
| metal salt (parts by weight) | | | | | | |
| Convenience | | ∘ | ∘ | ∘ | ∘ | ∘ |
| Propriety of pretreatment with first | | ∘ | ∘ | ∘ | ∘ | ∘ |
| composition alone | | | | | | |
| Storage | First composition alone | ∘ | ∘ | ∘ | ∘ | ∘ |
| stability | First composition + | ∘ | ∘ | ∘ | x | — |
| | second composition | | | | | |

| | | | | | | |
|---|---|---|---|---|---|---|
| Pretreatment | ΔE | — | — | — | — | 6.9 |
| agent | Assessment | — | — | — | — | F |
| application | | | | | | |
| trace | | | | | | |

| | | | | | |
|---|---|---|---|---|---|
| Washing fastness (JIS L1930 C4M | 4 | 4 | 4 | 4 | 2-3 |
| method, washing grade) | | | | | |
| Color development | ∘ | ∘ | ∘ | ∘ | ∘ |

| | | | Comparative Examples | | | | | | | | | |
|---|---|---|---|---|---|---|---|---|---|---|---|---|
| | | | 2 | | 3 | | 4 | | 5 | | 6 | |
| First composition/second composition | | | First | Second | First | Second | First | Second | First | Second | First | Second |
| Polyvalent | | Calcium nitrate | 18.0 | | 18.0 | | 18.0 | | 18.0 | | | |
| metal salt | | tetrahydrate | | | | | | | | | | |
| Resin emulsion | | Acrylic emulsion | 4.5 | | 4.5 | | 4.5 | | 4.5 | | 4.5 | |
| Amino | Betaine | Trimethylglycine | | | | | | | | | | |
| acid | Non- | Carnitine | | | | | | | | | | |
| | betaine | Glycine | | | | | | | | | | |

| | | | | | | | | | | |
|---|---|---|---|---|---|---|---|---|---|---|
| Cross- | EPOCROS ® | | | | | | | | | |
| linking | WS-700 (*1) | | | | | | | | | |
| agent | CARBODILITE ® | | 0.5 | | 1.0 | | 1.5 | | 5.0 | |
| | V-02 (*2) | | | | | | | | | |
| Surfactant | OLFINE ® | 0.5 | | 0.5 | | 0.5 | | 0.5 | | 0.5 |
| | E1010 (*3) | | | | | | | | | |
| Preservative | PROXEL ™ | 0.1 | | 0.1 | | 0.1 | | 0.1 | | 0.1 |
| | GXL(S)(*4) | | | | | | | | | |

| | | | | | |
|---|---|---|---|---|---|
| Water | Balance | Balance | Balance | Balance | Balance |

| Content ratio of amino acid relative | | — | — | — | — | — |
|---|---|---|---|---|---|---|
| to 100 parts by weight of polyvalent | | | | | | |
| metal salt (parts by weight) | | | | | | |
| Content ratio of cross-linking agent relative | | 11.1 | 22.2 | 33.3 | 111.1 | — |
| to 100 parts by weight of polyvalent | | | | | | |
| metal salt (parts by weight) | | | | | | |
| Convenience | | ∘ | ∘ | ∘ | ∘ | ∘ |
| Propriety of pretreatment with first | | ∘ | ∘ | ∘ | ∘ | x |
| composition alone | | | | | | |
| Storage | First composition alone | ∘ | ∘ | ∘ | ∘ | — |
| stability | First composition + | x | ∘ | ∘ | x | — |
| | second composition | | | | | |

| | | | | | | |
|---|---|---|---|---|---|---|
| Pretreatment | ΔE | — | — | — | — | — |
| agent | Assessment | — | — | — | — | — |
| application | | | | | | |
| trace | | | | | | |

| | | | | | |
|---|---|---|---|---|---|
| Washing fastness (JIS L1930 C4M | 2-3 | 2-3 | 2 | 2-3 | — |
| method, washing grade) | | | | | |
| Color development | ∘ | ∘ | ∘ | ∘ | — |

Footnotes in Table 3
(*1) oxazoline group-containing compound, manufactured by Nippon Shokubai Co., Ltd.;
(*2) carbodiimide-containing compound, manufactured by Nisshinbo Chemical Inc.;
(*3) manufactured by Nissin Chemical Industry Co., Ltd.;
(*4)manufactured by Lonza K.K.

TABLE 4

| | | | Comparative Examples | | | | | | | | | | | |
|---|---|---|---|---|---|---|---|---|---|---|---|---|---|---|
| | | | 7 | | 8 | | 9 | | 10 | | 11 | | 12 | |
| First composition/second composition | | | First | Second | First | Second | First | Second | First | Second | First | Second | First | Second |
| Polyvalent | | Calcium nitrate | ● | | ● | | ● | | | ● | | ● | | ● |
| metal salt | | tetrahydrate | | | | | | | | | | | | |
| Resin emulsion | | Acrylic emulsion | ● | | ● | | ● | | ● | | ● | | ● | |
| Amino | Betaine | Trimethylglycine | ● | | | | ● | | ● | | | | ● | |
| acid | Non- | Carnitine | | | | | | | | | | | | |
| | betaine | Glycine | | | | | | | | | | | | |

| | | | | | | | |
|---|---|---|---|---|---|---|---|
| Cross- | EPOCROS ® | | ● | ● | | ● | ● |
| linking | WS-700 (*1) | | | | | | |
| agent | CARBODILITE ® | | | | | | |
| | V-02 (*2) | | | | | | |
| Surfactant | OLFINE ® | ● | ● | ● | ● | ● | ● |
| | E1010 (*3) | | | | | | |
| Preservative | PROXEL ™ | ● | ● | ● | ● | ● | ● |
| | GXL(S)(*4) | | | | | | |

| | | | | | | |
|---|---|---|---|---|---|---|
| Water | ● | ● | ● | ● | ● | ● |

| | | | | | | |
|---|---|---|---|---|---|---|
| Convenience | x | x | x | ∘ | ∘ | ∘ |
| Propriety of pretreatment with first | ∘ | ∘ | ∘ | x | x | x |
| composition alone | | | | | | |

Footnotes in Table 4
(*1) oxazoline group-containing compound, manufactured by Nippon Shokubai Co., Ltd.;
(*2) carbodiimide-containing compound, manufactured by Nisshinbo Chemical Inc.;
(*3) manufactured by Nissin Chemical Industry Co., Ltd.;
(*4)manufactured by Lonza K.K. In Table 4, the closed circle (●) indicates the case of including each of the components summarized in Table 4, and the blank indicates the case of not including each of the components summarized in Table 4.

As summarized in Tables 1 to 3, the pretreatment agent sets of Examples 1 to 14 are highly convenient because the first composition and the second composition are being separated from each other at the time of purchase by the user of performing the pretreatment. In particular, in the case where the second composition contains high-cost component as in Comparative Examples 7 to 9, the burden of costs of the user increases when the first composition and the second composition are mixed in advance. In contrast, the pretreatment agent sets of Examples 1 to 14 are highly convenient in terms of cost because the first composition and the second composition are being separated from each other at the time of purchase by the user.

In addition, unlike the pretreatment agent set of Comparative Example 6 not including polyvalent metal salt as the first composition, the pretreatment agent sets of Examples 1 to 14 including polyvalent metal salt as the first composition had ΔL* of 80 or more in “propriety evaluation of pretreatment with first composition alone”, and therefore, it was found that the first composition alone had a pretreatment effect. That is, the pretreatment agent sets of Examples 1 to 14 provide, by performing the pretreatment using the first composition alone or using the first composition mixed with the second composition as needed, the user an option to add an appropriate function to the first composition (for example, reduce pretreatment traces, improve washing fastness, and the like).

Further, in the pretreatment agent sets of Examples 1 to 14, the concentration ratio of the first composition and the concentration ratio of the second composition may be appropriately adjusted. Thus, for example, the user may adjust the extent of addition of functions to the first composition as needed.

In addition, the pretreatment agent sets of Examples 1 to 14 had good storage stability with the first composition alone.

In addition to the above, as summarized in Table 1, the pretreatment agent sets including trimethylglycine as the second composition (Examples 1 to 7) had good results for the pretreatment agent application trace evaluation. Further, as summarized in Table 2, the pretreatment agent set including carnitine or glycine as the amino acid (Example 9 or 10), had good results for the pretreatment agent application trace evaluation.

Further, as summarized in Table 3, the pretreatment agent sets including a cross-linking agent containing an oxazoline group-containing compound as the second composition (Examples 11 to 14) had better washing fastness evaluation result than the pretreatment agent sets not including a cross-linking agent containing an oxazoline group-containing compound as the second composition (Comparative Examples 1 to 5).

On the other hand, as described above, unlike the pretreatment agent sets including polyvalent metal salt as the first composition (Examples 1 to 14), the pretreatment agent set not including polyvalent metal salt as the first composition (Comparative Example 6) had ΔL* of 27 in “propriety evaluation of pretreatment with first composition alone”. That is, the pretreatment agent set of Comparative Example 6 did not achieve the pretreatment with the first composition alone.

The conventional pretreatment agents (Comparative Examples 7 to 9) had poor convenience because the first composition and the second composition were in the mixed form at the time of purchase by the user.

Furthermore, when polyvalent metal salt was separated from the first composition (Comparative Examples 10 to 12) the pretreatment was not achieved with the first composition alone.

Some or all of the above embodiments and examples may be described as follows, but are not limited thereto.

### (Supplementary Note 1)

A composition being a second composition to be applied to a fabric prior to ejection of a pigment ink by an ink-jet printer and mixed at a time of pretreatment with a first composition containing water and at least one of a polyvalent metal salt, a polymer, or a surfactant, wherein the second composition contains at least one of an amino acid or a cross-linking agent, and the cross-linking agent contains an oxazoline group-containing compound.

### (Supplementary Note 2)

The composition according to Supplementary Note 1, wherein the amino acid is betaine.

### (Supplementary Note 3)

The composition according to Supplementary Note 2, wherein the betaine is trimethylglycine.

### (Supplementary Note 4)

The composition according to any one of Supplementary Notes 1 to 3, wherein the second composition contains at least a cross-linking agent, and the cross-linking agent is an oxazoline group-containing compound.

### (Supplementary Note 5)

The composition according to any one of Supplementary Notes 1 to 4, wherein the first composition contains the polyvalent metal salt, the second composition contains at least an amino acid, and a content ratio of the amino acid contained in the second composition relative to 100 parts by weight of the polyvalent metal salt is greater than 0 parts by weight and less than or equal to 200 parts by weight.

### (Supplementary Note 6)

The composition according to any one of Supplementary Notes 1 to 5, wherein the first composition contains the polymer, the second composition contains at least a cross-linking agent and a content ratio of the cross-linking agent contained in the second composition relative to 100 parts by weight of the polymer is greater than 0 parts by weight and less than or equal to 120 parts by weight.

### (Supplementary Note 7)

The composition according to any one of Supplementary Notes 1 to 6, wherein the composition is diluted with water at the time of pretreatment.

### (Supplementary Note 8)

A pretreatment agent set to be applied to a fabric prior to ejection of a pigment ink by an ink-jet printer, including: a first composition; and a second composition, wherein the first composition contains water and at least one of a polyvalent metal salt, a polymer, or a surfactant, the second composition contains at least one of an amino acid or a cross-linking agent, and the cross-linking agent contains an oxazoline group-containing compound.

### (Supplementary Note 9)

The pretreatment agent set according to Supplementary Note 8, wherein the amino acid is betaine.

### (Supplementary Note 10)

The pretreatment agent set according to Supplementary Note 9, wherein the betaine is trimethylglycine.

### (Supplementary Note 11)

The pretreatment agent set according to any one of Supplementary Notes 8 to 10, wherein the second composition contains at least a cross-linking agent, and the cross-linking agent is an oxazoline group-containing compound.

### (Supplementary Note 12)

The pretreatment agent set according to any one of Supplementary Notes 8 to 11, wherein the first composition contains the polyvalent metal salt, the second composition contains at least an amino acid, and a content ratio of the amino acid contained in the second composition relative to 100 parts by weight of the polyvalent metal salt is greater than 0 parts by weight and less than or equal to 200 parts by weight.

### (Supplementary Note 13)

The pretreatment agent set according to any one of Supplementary Notes 8 to 12, wherein the first composition contains the polymer, the second composition contains at least a cross-linking agent, and a content ratio of the cross-linking agent contained in the second composition relative to 100 parts by weight of the polymer is greater than 0 parts by weight and less than or equal to 120 parts by weight.

### (Supplementary Note 14)

A composition to be applied to a fabric prior to ejection of a pigment ink by an ink-jet printer, wherein the composition is a second composition containing at least one of an amino acid or a crosslinking agent, the cross-linking agent contains an oxazoline group-containing compound, and the composition is mixed at a time of pretreatment with a first composition containing water and at least one of a polyvalent metal salt, a polymer, or a surfactant.

### (Supplementary Note 15)

A method for pretreating a fabric to be printed by ejecting a pigment ink by an ink-jet printer, including: pretreatment agent mixing; and pretreating, wherein, in the pretreatment agent mixing, a first composition is mixed with a second composition, the first composition contains water and at least one of a polyvalent metal salt, a polymer, or a surfactant, and the second composition contains at least one of an amino acid or a cross-linking agent, and the cross-linking agent contains an oxazoline group-containing compound, and, in the pretreating, the fabric is pretreated with the first composition mixed with the second composition.

### (Supplementary Note 16)

A method for forming an image on a fabric using an ink-jet printer, including: pretreating; and image forming, wherein, in the pretreating, the fabric is pretreated with a first composition mixed with a second composition, the first composition contains water and at least one of a polyvalent metal salt, a polymer, or a surfactant, and the second composition contains at least one of an amino acid or a cross-linking agent, and the cross-linking agent contains an oxazoline group-containing compound, and, in the image forming, an image is formed on the pretreated fabric by printing.

While the invention has been described in conjunction with various example structures outlined above and shown in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A composition being a second composition to be applied to a fabric prior to ejection of a pigment ink by an ink-jet printer and mixed at a time of pretreatment with a first composition containing water and at least one of a polyvalent metal salt, a polymer, or a surfactant, wherein
the second composition contains at least one of an amino acid or a cross-linking agent, and
the cross-linking agent contains an oxazoline group-containing compound.

2. The composition according to claim 1, wherein
the amino acid is betaine.

3. The composition according to claim 2, wherein
the betaine is trimethylglycine.

4. The composition according to claim 1, wherein
the second composition contains at least a cross-linking agent, and
the cross-linking agent is an oxazoline group-containing compound.

5. The composition according to claim 1, wherein
the first composition contains the polyvalent metal salt,
the second composition contains at least an amino acid, and
a content ratio of the amino acid contained in the second composition relative to 100 parts by weight of the polyvalent metal salt is greater than 0 parts by weight and less than or equal to 200 parts by weight.

6. The composition according to claim 1, wherein
the first composition contains the polymer,
the second composition contains at least a cross-linking agent, and
a content ratio of the cross-linking agent contained in the second composition relative to 100 parts by weight of the polymer is greater than 0 parts by weight and less than or equal to 120 parts by weight.

7. The composition according to claim 1, wherein
the composition is diluted with water at the time of pretreatment.

8. A pretreatment agent set to be applied to a fabric prior to ejection of a pigment ink by an ink-jet printer, comprising:
a first composition; and
a second composition, wherein
the first composition contains water and at least one of a polyvalent metal salt, a polymer, or a surfactant,
the second composition contains at least one of an amino acid or a cross-linking agent, and
the cross-linking agent contains an oxazoline group-containing compound.

9. The pretreatment agent set according to claim 8, wherein
the amino acid is betaine.

10. The pretreatment agent set according to claim 9, wherein
the betaine is trimethylglycine.

11. The pretreatment agent set according to claim 8, wherein
the second composition contains at least a cross-linking agent, and
the cross-linking agent is an oxazoline group-containing compound.

12. The pretreatment agent set according to claim 8, wherein
the first composition contains the polyvalent metal salt,
the second composition contains at least an amino acid, and
a content ratio of the amino acid contained in the second composition relative to 100 parts by weight of the polyvalent metal salt is greater than 0 parts by weight and less than or equal to 200 parts by weight.

13. The pretreatment agent set according to claim 8, wherein
the first composition contains the polymer,
the second composition contains at least a cross-linking agent, and
a content ratio of the cross-linking agent contained in the second composition relative to 100 parts by weight of the polymer is greater than 0 parts by weight and less than or equal to 120 parts by weight.

14. A composition to be applied to a fabric prior to ejection of a pigment ink by an ink-jet printer, wherein
the composition is a second composition containing at least one of an amino acid or a crosslinking agent,
the cross-linking agent contains an oxazoline group-containing compound, and
the composition is mixed at a time of pretreatment with a first composition containing water and at least one of a polyvalent metal salt, a polymer, or a surfactant.

15. A method for pretreating a fabric to be printed by ejecting a pigment ink by an ink-jet printer, comprising:
pretreatment agent mixing; and
pretreating, wherein
in the pretreatment agent mixing, a first composition is mixed with a second composition,
the first composition contains water and at least one of a polyvalent metal salt, a polymer, or a surfactant, and
the second composition contains at least one of an amino acid or a cross-linking agent, and
the cross-linking agent contains an oxazoline group-containing compound, and
in the pretreating, the fabric is pretreated with the first composition mixed with the second composition.

16. A method for forming an image on a fabric using an ink-jet printer, comprising:
pretreating; and
image forming, wherein
in the pretreating, the fabric is pretreated with a first composition mixed with a second composition,
the first composition contains water and at least one of a polyvalent metal salt, a polymer, or a surfactant, and
the second composition contains at least one of an amino acid or a cross-linking agent, and
the cross-linking agent contains an oxazoline group-containing compound, and
in the image forming, an image is formed on the pretreated fabric by printing.
